(19) United States
(12) Patent Application Publication
(10) Pub. No.: US 2008/0300940 A1
(43) Pub. Date: Dec. 4, 2008

(54) Capturing Consumer Requirements

(76) Inventor: Gosakan Aravamudan, Bangalore (IN)

Correspondence Address: Ashok Tankha, 36 Greenleigh Drive, Sewell, NJ, 08080, US

(21) Appl. No.: 12/129,678

(22) Filed: May 30, 2008

(30) Foreign Application Priority Data
May 31, 2007 (IN) 1132/CHE/2007

(51) Int. Cl. G06Q 30/00

(52) U.S. Cl. 705/7

(57) ABSTRACT

Disclosed herein is a computer implemented method and system for capturing desires and needs of a consumer. A toolbar application is provided to the consumer. The toolbar application accepts inputs from the consumer. The inputs are desires and needs of the consumer. The inputs of the consumer are transmitted to a central intelligence server. The central intelligence server analyzes the inputs and categorizes the inputs of the consumer into product and service categories. The categorized inputs of the consumer are then sold to the vendors of the related products and services. The toolbar application thereby enables the vendors to capture the desires and needs of the consumer.

### CROSS REFERENCE TO RELATED APPLICATIONS

This application claims the benefit of the Indian patent application 1132/CHE/2007 titled “Capturing Consumer Requirements”, filed on May 31, 2007 in the Indian Patent Office.

### BACKGROUND

This invention, in general, relates to electronic commerce. More particularly, this invention relates to capture of the requirements of consumers.

In today's highly competitive business environment, it is crucial to be the first to market a new product or service. In order to be the first to market, the product designer must have a pulse on the market at all points in time, capture the consumer requirements accurately and respond rapidly to new trends and consumer requirements.

Consumers changing needs and preferences are difficult to model and hypothesize using existing market research techniques. Market research is currently performed by phone interviews, personal interviews, and focus groups. Many of these current methods are applied to a small segment of consumers and may not be representative of the entire population. Market research is typically performed at one point in time. However, consumer needs and preferences are dynamic variables. The current market research techniques are not geared towards monitoring the consumer needs on a continuous basis over an extended period of time.

Internet polling for market research is gaining popularity. However, existing methods of internet polling requires consumers to actively respond to a market research request, accept the request, sign in and take part in a structured market research activity. These methods would be inconvenient for a consumer and hence make the consumer less inclined to take part in such a survey.

The design of new products and services are dictated both by consumers' wants and needs. The current means of market research typically capture the “needs” of consumers and do not necessarily capture the “wants” of consumers effectively. In this context, “needs” are usually basic and ‘must-have’ requirements, whereas “wants” are typically value added preferences.

Consumers, while browsing company websites, usually provide their inputs or feedback via a webpage with a form that needs to be filled with a feedback, comment or a consumer requirement. However, the consumer may have difficulty in locating such a webpage, and will further be inconvenienced by having to fill in forms with fields that compulsorily need to be filled in.

Existing market research and consumer response management (CRM) feedback methods are applied in a structured environment, wherein a structured environment represents one or more of the following conditions: the consumer is aware that he or she is being surveyed, the survey is conducted at a particular point in time, the consumer is responding to a structured question or a feedback request. In general, people dislike filling forms and are averse to taking part in structured surveys.

Hence, there is an unmet market need for a computer implemented method and system that captures consumer requirements in real time, at a time convenient for the consumer, over an extended period of time, and in an unstructured environment. Moreover, there is a need for capturing both wants and needs of consumers thereby enabling a convenient method of providing feedback and comments while browsing websites.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein, addresses the above stated unmet market needs for capturing consumer requirements at a point in time and location that is convenient for the consumer. Moreover, the computer implemented method and system disclosed herein captures both the wants and needs of the consumers, especially their “wishes” of products or services, that is either unavailable in the market or is unaffordable or inaccessible to them. The computer implemented method and system disclosed herein also provides a means of capturing consumer feedback and comments while browsing websites and provides information on consumer desires and projected buying behavior.

The computer implemented method and system disclosed herein provides a ‘wish’ toolbar application to capture the desires and needs of a consumer. The consumers input their wishes into the ‘wish’ toolbar application. These ‘wish’ inputs are transmitted to the central intelligence server of a service provider. The central intelligence server analyzes the transmitted inputs and categorizes the analyzed inputs of the consumer into product and service categories. The central intelligence server also filters out junk correspondences, undesired bulk messages, and spam. The categorized inputs of the consumer are then sold to the vendors of the related products and services. Vendors may conduct polling operations to obtain consumer opinions on the products and services. Polling is initiated when a polling request is received by the ‘wish’ toolbar application from a website conducting polls.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method of capturing desires and needs of a consumer.

FIG. 2 illustrates a computer implemented system for capturing desires and needs of a consumer.

FIG. 3 illustrates an exemplary process flow representation of the ‘wish’ toolbar application.

### DETAILED DESCRIPTION OF THE INVENTION

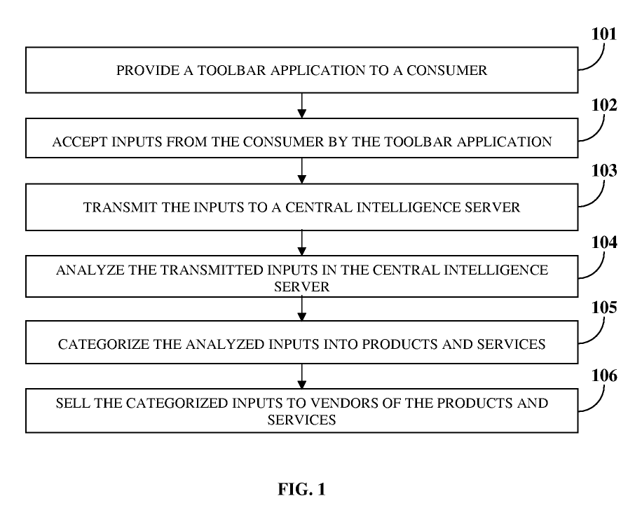

FIG. 1 illustrates a computer implemented method of capturing desires and needs of a consumer 201. As used herein, the term “consumer” refers to any user who has a wish, desire, and product or service requirement. The desires and needs of the consumer 201 are captured using a toolbar application 202a provided on a computing device 202 of the consumer 201. The toolbar application 202a herein referred to as a ‘wish’ toolbar application 202a is provided 101 by a service provider through a host website. Prior to using this toolbar application 202a, the consumer 201 and vendors 205 may register on the host website. As used herein, the term “vendors” refers to any individual or organization that uses the inputs associated with the desires or needs of the consumer 201 to develop or manufacture new products and services or to sell products and services.

During registration and enrollment, consumers may submit their profiles to a central intelligence server 204 of the service provider. The profile of the consumer 201 includes the consumer name, address, age, occupation, demographic information, etc. The consumer 201 may also request for promotional offers from the vendors 205. The vendors 205 may utilize the consumer's 201 profile to assess the consumer's 201 inputs. The ‘wish’ toolbar application 202a may be utilized in the following scenarios.

In a first embodiment of the method disclosed herein, the ‘wish’ toolbar application 202a is downloaded from the host website of the service provider and installed onto the computing device 202 of the consumer 201 or installed during assembling of the product or plugged-in, or pre-loaded on the computing device 202. The ‘wish’ toolbar application 202a may also be pre-burned onto the read only memory (ROM) of a mobile device. In this embodiment, the identity of the consumer 201 is established by the internet protocol address of the computing device 202 on which the toolbar application 202a resides.

In a second embodiment of the method disclosed herein, the ‘wish’ toolbar application 202a is accessed directly from the host website of the service provider. Here, the toolbar application 202a requires a sign-in authentication with the consumer name and password.

In a third embodiment of the method disclosed herein, the ‘wish’ toolbar application 202a is hosted on a partner website on behalf of the host website of the service provider. A partner website is a website that allows the service provider to promote the ‘wish’ tool bar application. The partner website allows consumers to utilize the ‘wish’ toolbar application 202a while they browse through the partner websites. When the consumer 201 is navigating through a partner website, any wishes inputted in the ‘wish’ toolbar application 202a residing on the partner website is automatically routed to the central intelligence server 204 of the service provider. In this embodiment, no sign-in feature is required and the identity of the consumer 201 is established by the internet protocol address of the consumer's 201 device location.

In a fourth embodiment of the method disclosed herein, the ‘wish’ toolbar application 202a resides on vendor websites. The vendors 205 subscribe for the ‘wish’ toolbar application 202a from the service provider and download the ‘wish’ toolbar application 202a onto their websites. In the fourth embodiment, the vendors 205 may access the inputs of the consumers either from the vendors' 205 server or by requesting for the consumer inputs from the central intelligence server 204 of the service provider. The ‘wish’ toolbar application 202a on the vendors' 205 website requires a sign-in authentication with a consumer name and password to establish the identity of the consumer 201.

The ‘wish’ toolbar application 202a accepts 102 inputs from the consumers in one or more modes of communication. The consumer 201 may use text, voice, keypad, stylus, haptic, and other modes to interface with the ‘wish’ toolbar application 202a. The ‘wish’ toolbar application 202a then transmits 103 the inputs information obtained from the computing device 202 of the consumer 201, the host website or the partner websites to the central intelligence server 204 of the service provider via a network 203. The transmission of inputs takes place in real-time or non-real time. If the computing device 202 of the consumer 201 is not connected to the network 203 while the consumer 201 is inputting their wish into the ‘wish’ toolbar application 202a, the wish information is stored temporarily in the consumer's 201 computing device 202 and the wish information is transmitted after the consumer 201 gets connected to the network 203. The central intelligence server 204 of the host website retrieves the input information periodically from the locally stored data.

The central intelligence server 204 analyzes 104 the transmitted inputs and categorizes 105 the analyzed inputs into products and services. The categorized inputs are then stored in the information database 204a. Depending on the requirement of the vendors 205, the categorized inputs are retrieved from the information database 204a and may be sold 106 to the vendors 205 of the related products or services by the service provider. The vendors 205 pay the service provider to access the categorized inputs of the consumer 201. A predetermined amount of the payment is disbursed to the consumer 201 through a micro-payment scheme. Micro-payments are means of disbursing small amounts of money to the consumer 201. These micro-payments are accumulated and collected as one regular payment after a period of time.

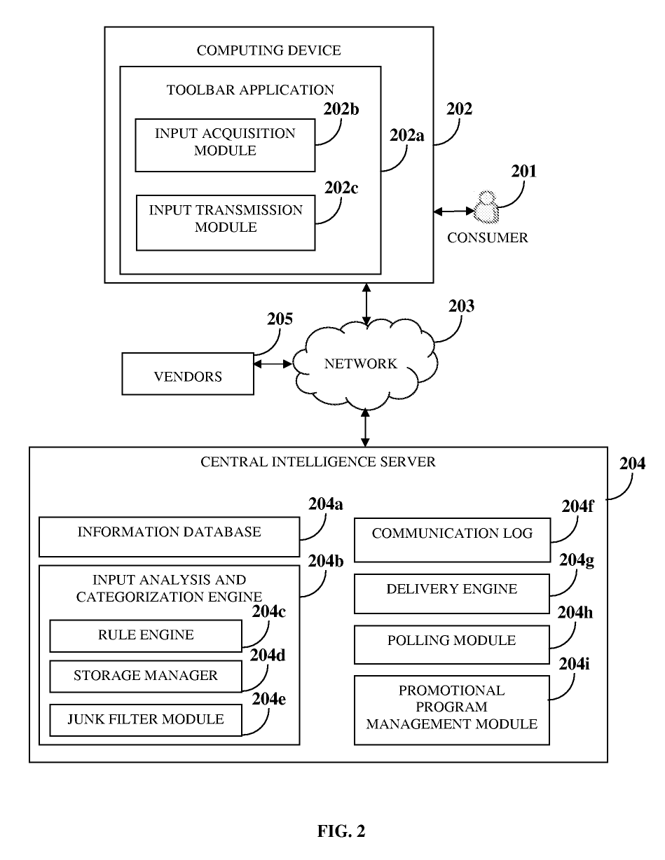

FIG. 2 illustrates a computer implemented system for capturing desires and needs of a consumer 201. The computer implemented system disclosed herein comprises a toolbar application 202a and a central intelligence server 204 connected via a network 203. The consumer 201 may access the toolbar application 202a by using a computing device 202 in communication with the network 203.

The computing device 202 operated by the consumer 201 may be a personal computer, a mobile phone, an electronic hand-held device, an electronic pager or any electronic device comprising computing, communication, and display modules. The ‘wish’ toolbar application 202a may be downloaded from the host website of the service provider onto the computing device 202 of the consumer 201. The consumer 201 may also access the ‘wish’ toolbar application 202a through the host website of the service provider or by navigating through partner websites, or also by logging in to a vendor website. The toolbar application 202a comprises an input acquisition module 202b and an input transmission module 202c. The input acquisition module 202b accepts the ‘wish’ inputs or requirements entered by the consumer 201. The input transmission module 202c transmits the inputs to the central intelligence server 204 of the service provider via the network 203. When the consumer 201 is not connected to the network 203, the ‘wish’ inputs may be stored temporarily in the computing device 202, and transmitted to the central intelligence server 204 after the computing device 202 gets connected to the network 203.

The network 203 connects the ‘wish’ toolbar application 202a, the vendors 205, and the central intelligence server 204. The computer implemented system disclosed herein is operable on a variety of mobile networks including advanced mobile phone service (AMPS), code division multiple access (CDMA), global system for mobile communications (GSM), digital cellular telephone system, general packet radio service (GPRS), time division multiple access (TDMA), digital cellular telephone system, universal mobile telecommunications system, satellite communication network or a public network such as the internet or local area network or the wide area network.

The central intelligence server 204 comprises an information database 204a, an input analysis and categorization engine 204b, a communication log 204f, a delivery engine 204g, a polling module 204h, and a promotional program management module 204i. The information database 204a collects the consumer inputs captured in the ‘wish’ toolbar application 202a and stores the inputs for retrieval by the vendors 205. The information database 204a also stores a classified list of vendor profiles and their products and services. The information database 204a may be a relational database with multiple tables for maintaining relationships between the names of vendors 205 and their respective products and services, names of consumers and their profiles, and wishes of consumers and their categorizations into products and services. The wishes inputted by the consumer 201 may be tagged through a ‘tag’ text field provided in the ‘wish’ toolbar application 202a. These tags are single word descriptors or keywords which help in categorization of the inputs in the central intelligence server 204.

The input analysis and categorization engine 204b comprises a rule engine 204c, a storage manager 204d, and a junk filter module 204e. The input analysis and categorization engine 204b collects the transmitted inputs stored in the information database 204a, detects and corrects errors in a data set and analyzes the transmitted inputs to determine a specific characteristic of the input. The input analysis and categorization engine 204b then categorizes the analyzed inputs into products and services. A predefined rule of the rule engine 204c is applied to the specific characteristic of the input. The rule engine 204c applies at least one rule to at least one characteristic of the input, and then selects the storage option in the information database 204a according to the satisfied rule. The storage option is selected based on the product and service categories. The rule engine 204c filters and discards the characteristics of the input that do not match with the predefined rule. The rule engine 204c, therefore, operates as a filter, for determining the most appropriate storage option for the inputs. The storage manager 204d then implements the storage decision made by the rule engine 204c and stores the categorized inputs in the information database 204a based on the product and service categories.

The junk filter module 204e filters out junk correspondences, undesired bulk messages, and spam. The consumer 201 may be permitted to transmit a predetermined number of ‘wish’ inputs in a predetermined period of time in order to eliminate spam. The ‘wish’ inputs which exceed this predetermined number will be deleted and a message indicating that they have exceeded the predetermined number of wish inputs will be communicated to the consumer 201. In addition, the time, date and input information of the consumer's 201 ‘wish’ inputs are captured in the communication log 204f. The communication log 204f further stores the information of the vendors 205. The maintenance of this communication log 204f is required to avoid spam and junk correspondences. The consumers who are found abusing the ‘wish’ toolbar application 202a will be excluded from using the ‘wish’ toolbar application 202a by establishing their identities from their consumer names, or by determining the internet protocol addresses of their computing devices.

The delivery engine 204g then delivers the categorized inputs stored in the information database 204a to the vendors 205 based on the vendor profiles stored in the information database 204a. The categorized inputs may be sold to the vendors 205 according to the vendors' 205 requirements. In one embodiment of the method and system disclosed herein, the vendors 205 are required to pay the service provider to access the categorized inputs of the consumers. Payments received by the service provider from the vendors 205 may be disbursed to the consumer 201 through a micro-payment scheme. In another embodiment of the method and system disclosed herein, the vendors 205 directly reward the consumer 201 by awarding them points for each wish inputted into the ‘wish’ toolbar application 202a. These points may later be redeemed for rewards in the form of products and services. When the vendor retrieves information from the information database 204a or when they send messages to target consumers, the time, date, content of the information and activities performed by the vendors 205 are recorded in the communication log 204f.

Vendors 205 may utilize the consumer inputs to develop new products and services. The vendors 205 manage promotional programs using the promotional program management module 204i of the central intelligence server 204. The vendors 205 may declare prizes for consumers whose input wish matches winning criteria. Vendors 205 may also transmit promotional or purchase oriented information to the consumer's 201 electronic mailbox. The consumer's 201 electronic mailbox may either be an existing electronic mail (email) account of the consumer 201 or an email account created during registration at the host website of the service provider.

On reviewing the wishes of the consumer 201, vendors 205 may also send advertisements to the consumer's 201 electronic mailbox based on the desires and needs of the consumer 201. Advertisements may also be sent to the consumer's 201 electronic mailbox according to their demands during registration and enrollment. Vendors 205 may also advertise awards to the consumers whose wishes have a significant impact on their respective businesses; for example, an input that results in the design of a new product or service. In this case, the award commitments are recorded at the central intelligence server 204, and the central intelligence server 204 monitors and manages the commitment and distribution of rewards to the consumers.

The ‘wish’ toolbar application 202a may be used in a variety of applications for capturing consumer's 201 feedback. For example, the ‘wish’ toolbar application 202a may be used for conducting market surveys and polling activities. Polling is used to determine preferences, needs, desires, and feedback of the consumers with respect to subject matter of a poll and this information may be used for demographic analysis. The polling module 204h enables the vendors 205 to conduct polling operations for obtaining consumer opinions on the products and services. The polling module 204h sends a polling request to the ‘wish’ toolbar application 202a from a website or a vendor conducting polls. The information received is, in turn, the means to identify and assess end points such as advertising, competitive position, job performance, product performance, price sensitivity ratings, and satisfaction, in both the aggregate and demographic subgroups corresponding to the participant population. A vendor may conduct polling operations to obtain consumer opinion on the products and services. This polling activity is initiated on receiving a polling request within the ‘wish’ toolbar application 202a.

Consider an example of the computer implemented method and system disclosed herein. The consumer 201 may download and install the ‘wish’ toolbar application 202a on a computer. The computer is connected to the central intelligence server 204 of the service provider via the internet. The consumer 201 may enters a wish, for example, “I wish I had a cell phone with voice recognition”. This wish is transmitted to the central intelligence server 204 through the internet. The information database 204a of the central intelligence server 204 stores the wish for further usage. The input analysis and categorization engine 204b collects the ‘wish’ input stored in the information database 204a and analyses the ‘wish’ input to determine a specific characteristic of the input. Here, the specific characteristic of the input is an object and a service category i.e. a “cell phone” along with a “voice recognition capability” that has been requested by the consumer 201.

A predefined rule of the rule engine 204c is applied to the specific characteristic of the input. In the rule engine 204c, the predefined rule is applied to the sentence wherein at least one rule is applied to at least one characteristic of the input. Here, the “cell phone” is compared with “object” and “voice recognition capability” is compared with service category, wherein the words that do not match the predefined rule in the rule engine 204c such as “I”, “wish”, “a” and “had” are filtered and discarded to determine the storage option that is most appropriate for the inputs i.e., “cell phone” and “voice recognition”. These closely matched words according to the predefined rule are categorized and stored in the information database 204a depending on the product i.e. the cell phone and service category i.e. the voice recognition capability. The delivery engine 204g transmits the categorized request to the appropriate vendor, for example, “Nokia Corporation” if the vendor has subscribed to receive such requests. Further, if the vendor has to contact the consumer 201, for the purpose of surveys, or information or any advertisements of similar products requested by the consumer 201, the vendor may send an email to the consumer 201. The email is received in the consumer's 201 electronic mailbox.

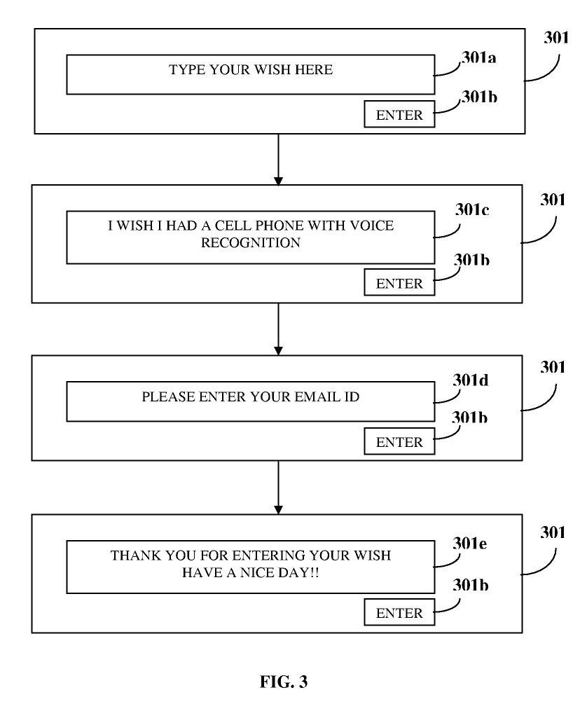

FIG. 3 illustrates an exemplary process flow representation of the ‘wish’ toolbar application 202a. When the consumer 201 inputs a wish, request or query on the interface 301 of the ‘wish’ toolbar application 202a located on the consumer's 201 computing device 202, on the host website of the service provider, partner websites or on vendor websites, the consumer input is restricted to a predefined set of characters. The consumer 201 may type 301a a wish, for example, “I wish I had a cell phone with voice recognition” 301c in the ‘wish’ toolbar application 202a. On pressing ‘enter’ 301b, the consumer input is transmitted to the central intelligence server 204 of the service provider via the network 203 or stored temporarily on the computing device 202 of the consumer 201. After the consumer 201 inputs a wish, an option to enter 301d an email id is provided. If the consumer 201 is not a registered or subscribed user and requires to be contacted by the vendor, the consumer 201 may provide the email id. The ‘wish’ toolbar application 202a may then confirm the receipt of the wish with a greeting 301e.

If the consumer 201 is registered at the host website of the service provider or at the vendor website, the consumer 201 may check the replies or advertisements sent by vendors 205, or view the accumulated payments, points and rewards in the electronic mailbox. If the consumer 201 is not registered and has not provided an email id while submitting the wish, no communication or payment will be sent to the consumer 201.

It will be readily apparent that the various methods and algorithms described herein may be implemented in a computer readable medium, e.g., appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors, or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as the information database 204a, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, Sun® processors, IBM® processors etc., that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A computer implemented method of capturing desires and needs of a consumer, comprising the steps of:
providing a toolbar application to said consumer;
accepting inputs from the consumer by said toolbar application, wherein said inputs comprise said desires and said needs of the consumer;
transmitting the inputs to a central intelligence server;
analyzing said transmitted inputs in said central intelligence server;
categorizing said analyzed inputs into products and services; and
selling said categorized inputs to vendors of said products and services;
whereby the toolbar application enables said vendors to capture the desires and needs of the consumer.

2. The computer implemented method of claim 1, wherein the toolbar application is provided by a service provider through a host website.

3. The computer implemented method of claim 1, further comprising a step of authenticating the consumer by the toolbar application prior to said acceptance of the inputs from the consumer whereby a unique identity is established for the consumer.

4. The computer implemented method of claim 1, wherein the toolbar application accepts the inputs from the consumer in a plurality of modes, wherein said modes comprise text, voice, haptic, and any combination thereof.

5. The computer implemented method of claim 1, wherein the inputs are obtained from one of a computing device of the consumer, host website of the service provider, a partner website, a vendor website, and any combination thereof.

6. The computer implemented method of claim 1, wherein said step of transmitting the inputs occurs in one of real time and non-real time.

7. The computer implemented method of claim 1, wherein the vendors subscribe to the central intelligence server for conducting polling operations to obtain consumer opinions on their products and services.

8. The computer implemented method of claim 7, wherein said polling operations are initiated when a polling request is received by the toolbar application from a website conducting polls.

9. The computer implemented method of claim 1, wherein the toolbar application accepts a predetermined number of inputs from the consumer within a predetermined period in order to eliminate spam.

10. The computer implemented method of claim 1, wherein the vendors transmit promotional and purchase oriented information to an electronic mailbox of the consumer.

11. The computer implemented method of claim 1, wherein the consumer is awarded points for each wish inputted into the toolbar application, wherein said points are redeemed for rewards in the form of products and services.

12. The computer implemented method of claim 1, wherein the vendors manage promotional programs using the central intelligence server, further wherein the vendors declare prizes for consumers whose input wish matches winning criteria.

13. The computer implemented method of claim 1, wherein the vendors pay the service provider to access the categorized inputs of the consumer, wherein a predetermined amount of said payment is disbursed to the consumer through a micro-payment scheme.

14. A computer implemented system for capturing desires and needs of a consumer, comprising:
a toolbar application comprising:
an input acquisition module for accepting inputs from said consumer, wherein said inputs comprise said desires and needs of the consumer;
an input transmission module for transmitting the inputs to a central intelligence server;
said central intelligence server comprising:
an input analysis and categorization engine for analyzing said transmitted inputs and categorizing said analyzed inputs into product and services; and
a delivery engine for delivering said categorized inputs to vendors of said products and services based on vendor profiles.

15. The computer implemented system of claim 14, wherein said toolbar application resides on one of a computing device of the consumer, host website of a service provider, a partner website, a vendor website, and any combination thereof.

16. The computer implemented system of claim 15, wherein said partner website hosts the toolbar application on behalf of said service provider.

17. The computer implemented system of claim 14, wherein a text field is provided in said toolbar application to display tags associated with each of the inputs to enable keyword based categorization of the inputs in the central intelligence server.

18. The computer implemented system of claim 14, wherein the central intelligence server further comprises an information database for storing the transmitted inputs of the consumer and a classified list of said vendor profiles and their products and services.

19. The computer implemented system of claim 14, wherein said input analysis and categorization engine comprises:
a rule engine for applying a predefined rule on the analyzed inputs of the consumer to select a storage option in the information database, wherein said storage option is selected based on product and service categories;
a storage manager for storing the analyzed inputs in the information database based on said product and service categories; and
a junk filter module for filtering out junk correspondences and spam.

20. The computer implemented system of claim 14, wherein the central intelligence server further comprises a communication log for capturing and storing time, date, and input information of the consumers and said vendors.

21. The computer implemented system of claim 14, wherein the central intelligence server further comprises a polling module for enabling said vendors to conduct polling operations for obtaining consumer opinions on the products and services.

22. The computer implemented system of claim 21, wherein said polling module sends a polling request from a website conducting polls to the toolbar application.

23. The computer implemented system of claim 14, the central intelligence server further comprises a promotional program management module for managing promotional programs of said vendors.

24. A computer program product comprising computer executable instructions embodied in a computer readable medium, wherein said computer program product comprises:
a first computer parsable program code for providing a toolbar application to a consumer, wherein said inputs are desires and needs of said consumer;
a second computer parsable program code for accepting the inputs from the consumer;
a third computer parsable program code for transmitting the inputs to a central intelligence server;
a fourth computer parsable program code for analyzing said transmitted inputs in said central intelligence server;
a fifth computer parsable program code for categorizing said analyzed inputs of the consumer into products and services; and
a sixth computer parsable program code for delivering said categorized inputs to vendors of said products and services.
